(19) United States
(12) Patent Application Publication
(10) Pub. No.: US 2009/0122756 A1
(43) Pub. Date: May 14, 2009

(54) METHOD AND SYSTEM FOR ESTABLISHING CLASSIFIER OF PRESET STREAM, AND USER TERMINAL THEREOF

(75) Inventors: Liang GU, Shenzhen (CN); Jianjun WU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/351,205

(22) Filed: Jan. 9, 2009

Related U.S. Application Data
(63) Continuation of application No. PCT/CN2007/070273, filed on Jul. 11, 2007.

(30) Foreign Application Priority Data
Jul. 11, 2006 (CN) 200610106528.2

(51) Int. Cl. H04W 72/04

(52) U.S. Cl. 370/329

(57) ABSTRACT

The present invention relates to the mobile communication field. A method and a system for establishing a classifier of preset stream, and a user terminal thereof are provided. In the present invention, after the user terminal succeeds in accessing a network, an initial service flow for carrying Layer 3 signals is established between the network side and the user terminal, and an IP address is assigned to the user terminal through an interaction of the Layer signals. After the IP address has been assigned successfully, a classifier of preset stream is established.

### CROSS-REFERENCE TO RELATED APPLICATIONS

The application is a continuation of International Patent Application No. PCT/CN2007/070273, filed Jul. 11, 2007, which claims priority to Chinese Patent Application No. 200610106528.2, filed Jul. 11, 2006, both of which are hereby incorporated by reference in their entirety.

### FIELD OF THE INVENTION

The present invention relates to the mobile communication field, and in particular, to a technique for establishing a classifier of preset stream in a Worldwide interoperability for Microwave Access (WiMAX) system.

### BACKGROUND

Recently, the broadband wireless access techniques, represented by the Local Multipoint Distribution System/Service (LMDS), the Microwave Multipoint Distribution System (MMDS), the Wireless Fidelity (Wi-Fi), and the WiMAX, have become a main force in the broadband access filed.

Compared with the wired access, such techniques have many advantages, such as low start-up investment, low initial input, short building period, rapid service provision, flexible development, being capable of dynamically distributing the system resources according to users' requirements, and low cost of system maintenance. Moreover, it is even difficult for some wired access techniques to catch up the high access rate of such techniques, thus, such techniques make it possible to develop a broadband data integrated service.

The WiMAX technique is a wireless metropolitan area network technique, which is a new air interface standard proposed for the microwave and millimeter wave frequency bands.

The WiMAX is adapted to connect a wireless access hot spot to the Internet, and may also connect an environment such as company and home to a wired backbone line. It may act as a wireless extended technique of the cable and digital subscriber line (DSL) to achieve a wireless broadband access. Due to the advantage of being low cost, the combination of this technique with a microwave device requiring an authorization or no authorization would expand the broadband wireless market and enhance the popularity of an enterprise and a service provider.

FIG. 1 shows a WiMAX end-to-end reference model. As shown in FIG. 1, the WiMAX mainly includes a Subscribe Station (SS)/Mobile Station (MS), an Access Service Network (ASN), and a Connectivity Service Network (CSN).

The ASN is defined as an aggregate of network functions of providing wireless access services for the WiMAX user terminal. The ASN includes network elements of a BS and an ASN gateway (ASN-GW), and one ASN may be shared by many CSNs.

The main functions of the ASN include the functions of the BS and the functions of the ASN-GW. The functions of the BS include providing a Layer 2 (L2) connection between the BS and the SS/MS, wireless resource management, measurement and power control, and compression and encryption of the air interface data. The functions of the ASN-GW include: providing a proxy function for the SS/MS Authentication, Authorization and Accounting (AAA) function, supporting the network discovery and selection of the network service provider (NSP), and providing a relay function of Layer 3 (L3) information for the SS, such as an IP address assignment.

The CSN is defined as providing an IP connection service for the WiMAX user terminal. The CSN mainly provides the following functions: IP address assignment for the SS/MS, Internet access, AAA protocol proxy or server, user-based authorization control, tunnel from the ASN to the CSN, accounting for the WiMAX users and settlement between the carriers, tunnel between the CSNs in the roaming case, switching between the ASNs, and various WiMAX services, such as location-based services, multimedia multicast and broadcast services, and IP multimedia subsystem services.

The MS/SS is a (mobile) user equipment, which the user uses to access the WiMAX network.

The WiMAX and the network architecture thereof have been illustrated above, and the conception of the classifier and the preset stream in the WiMAX network will be further illustrated below.

In a WiMAX network, the classifier is adapted to classify various services carried on the network into specific service flows of the carrier network. The service flow is the minimum operated object of assuring the Quality of Service (QoS) of the WiMAX carrier network, and different service flows may have different QoS assurances. The classifier may distribute the services to the respective service flows according to different QoS requirements of the upper services.

The classifier is composed of a series of classification rules. If an IP service is carried, one of the main classification parameters is the IP address. For example, for an IPv4 data packet, a particular IP packet can be classified to a certain service flow according to the source/destination IP address, the protocol type, and the source/destination Transmission Control Protocol (TCP)/User Datagram Protocol (UDP) port number. A classifier of uplink service is implemented on the user terminal (e.g., an MS), and a classifier of downlink service is implemented on a BS or an ASN-GW.

After the user terminal succeeds in accessing a network, the network side would usually pre-establish a related service channel according to the subscription information between the user terminal and the network service provider, including establishing an air interface and a corresponding data carrying channel at the network side, i.e., a preset stream.

Through the preset stream, the user terminal can use a corresponding service provided by the network. It should be noted that, the services carried on the preset stream also include a Layer 3 (i.e., the network layer) signal transmission.

The process of the user terminal accessing a network is illustrated in detail below. According to the prior art, as shown in FIG. 2, when the user terminal accesses the network, the process proceeds to Step 210 first, in which the user terminal initiates a process for initially accessing the network. After the user terminal succeeds in accessing the network, the process then proceeds to Step 220.

In Step 220, a related functional entity in the ASN-GW initiates a process for establishing a preset stream, in which corresponding classifiers are also created, according to the user terminal preset stream configuration issued by the AAA in the stage of initially accessing the network. The established classifiers include a classifier for the preset stream service and other classifiers for other services for classifying the upper services carried on the network into the service flows of the carrier network. The upper services carried on the network include all services and signals of the Layer 3 (i.e., the network layer) and above layers. The classifier of uplink service is created on the user terminal, and the classifier of downlink service is created on the BS or the ASN-GW.

After the preset stream service has been established, the process then proceeds to Step 230, in which by carrying Layer 3 signals on the established preset stream, a desired IP address is assigned to the user terminal. After the IP address has been assigned successfully, the IP address used by the corresponding user terminal is recorded by the ASN-GW.

In implementing the present invention, the inventor found that at least the following problems exit in the prior art. After the user terminal has initially accesses the network, a process for establishing a preset stream is initiated first, in which a preset stream service and a corresponding classifier of preset stream are established, and then an IP address is assigned to the user terminal by carrying the Layer 3 signals on the established preset stream. According to this operation sequence, while a classifier of preset stream is being established in the process of establishing the preset stream, the IP address of the user terminal has not been assigned, so that the user terminal IP address parameter of the established classifier of preset stream is null, and the classifier of preset stream having no IP address set up, cannot normally classify the preset stream service of the user terminal. That is, in practical application, the classifier of preset stream established according to the above scheme cannot work normally.

### SUMMARY

The present invention provides a method and a system for establishing a classifier of preset stream, so that the classifier of preset stream established at a network side and a user terminal side have a correct IP address, and can normally classify the preset stream services of the user terminal.

The present invention further provides a user terminal, which is able to normally classify the preset stream services of the user terminal.

The present invention provides a method for establishing a classifier of preset stream, which includes the following steps. After the user terminal succeeds in accessing a network, an initial service flow for carrying signals is established between a network side and a user terminal. With the signals carried on the initial service flow, an IP address is assigned to the user terminal. After the IP address has been assigned successfully, a classifier of preset stream is established according to the IP address.

In the method according to an embodiment of the present invention, after the user terminal succeeds in accessing the network, an initial service flow for carrying Layer 3 signals is established between the network side and the user terminal, and the IP address of the user terminal is assigned through an interaction of the Layer 3 signals, so that the IP address can be assigned to the user terminal successfully before the preset stream service is established, thereby ensuring that the network side can establish a corresponding classifier of preset stream with a correct IP address, and the established classifier of preset stream can normally classify the preset stream services of the user terminal. As a result, the phenomenon that the established classifier of preset stream cannot normally work due to a lack of the IP address of the user terminal in the prior art is avoided.

The present invention provides a method for establishing a classifier of preset stream, which includes the following steps. After the user terminal succeeds in accessing a network, a classifier of preset stream is established, in which the classifier of preset stream includes an uplink classifier of preset stream or a downlink classifier of preset stream. With the signals carried on the established preset stream, an IP address is assigned to the user terminal. After the IP address has been assigned successfully, the user terminal IP address parameter in the established classifier of preset stream is updated according to the assigned IP address.

In the method according to an embodiment of the present invention, after the user terminal succeeds in accessing the network, a classifier of preset stream is directly established. The parameters of the classifier of preset stream that are established after an IP address has been assigned to the user terminal successfully and before the address is modified can ensure the correctness of the user terminal IP address in the classifier of preset stream, so that the embodiments of the present invention ensure that the established classifier of preset stream can carry out the classification normally, and the modification to the prior art is minimized, thereby increasing the compatibility with the prior art.

The present invention further provides a system for establishing a classifier of preset stream, which includes:

a channel establishing device adapted to establish an initial service flow between a network side and a user terminal for carrying signals after the user terminal succeeds in accessing a network;

an address assigning device, adapted to assign an IP address to the user terminal through a signal interaction on the initial service flow established by the channel establishing device; and

a first classifier establishing device, adapted to establish a classifier of preset stream with the IP address after the address assigning device succeeds in assigning the IP address to the user terminal.

In the system according to an embodiment of the present invention, after the user terminal succeeds in accessing the network, an initial service flow for carrying Layer 3 signals is established between the network side and the user terminal, and the IP address of the user terminal is assigned through an interaction of the Layer 3 signals, so that the IP address has been assigned to the user terminal successfully before the preset stream service is established, thus ensuring that the network side can establish a corresponding classifier of preset stream with a correct IP address, and the established classifier of preset stream can normally classify the preset stream services of the user terminal.

The present invention further provides a system for establishing a classifier of preset stream, which includes:

a second classifier establishing device adapted to establish a classifier of preset stream after a user terminal succeeds in accessing a network;

an address assigning device adapted to assign an IP address to the user terminal by signals on the established preset stream; and

a preset stream parameter modifying device adapted to modify the user terminal IP address parameter in the established classifier of preset stream according to the IP address assigned to the user terminal by the address assigning device.

In the system according to the embodiments of the present invention, after the user terminal succeeds in accessing the network, a classifier of preset stream is directly established. The parameters of the classifier of preset stream that are established after an IP address has been assigned to the user terminal successfully and before the address is modified can ensure the correctness of the user terminal IP address in the classifier of preset stream, so that the embodiments of the present invention ensure that the established classifier of preset stream can carry out the classification normally, and the modification to the prior art is minimized, thereby increasing the compatibility with the prior art.

An embodiment of the present invention further provides a user terminal, which includes:

a unit adapted to establish an initial service flow for carrying signals with a network side after the user terminal succeeds in accessing a network;

a unit adapted to acquire an IP address assigned to the present user terminal by the network side after the initial service flow performs a signal interaction with the network side; and

a unit adapted to set up the parameters of the classifier of preset stream with the IP address after the IP address has been assigned successfully.

The user terminal according to the embodiments of the present invention can assure the correctness of the IP address of the user terminal in the classifier of preset stream, thus enabling the established classifier of preset stream to normally classify the preset stream services of the user terminal.

### BRIEF DESCRIPTION OF THE DRAWINGS

The present invention will become better understood from the detailed description given herein below for illustration only, and thus are not limitative of the present invention, and wherein:

FIG. 1 is a schematic structural view of a WiMAX network;

FIG. 2 is a flow chart of a user terminal accessing a network;

FIG. 3 is a flow chart of a method for establishing a classifier of preset stream according to a first embodiment of the present invention; and

FIG. 4 is a flowchart of a method for establishing a classifier of preset stream according to a third embodiment of the present invention.

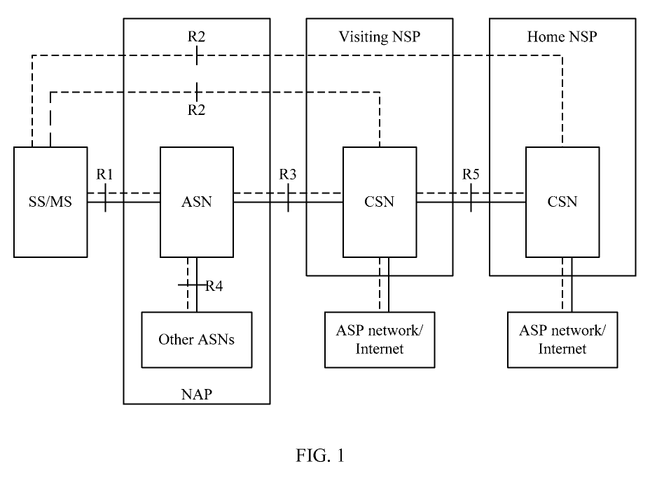

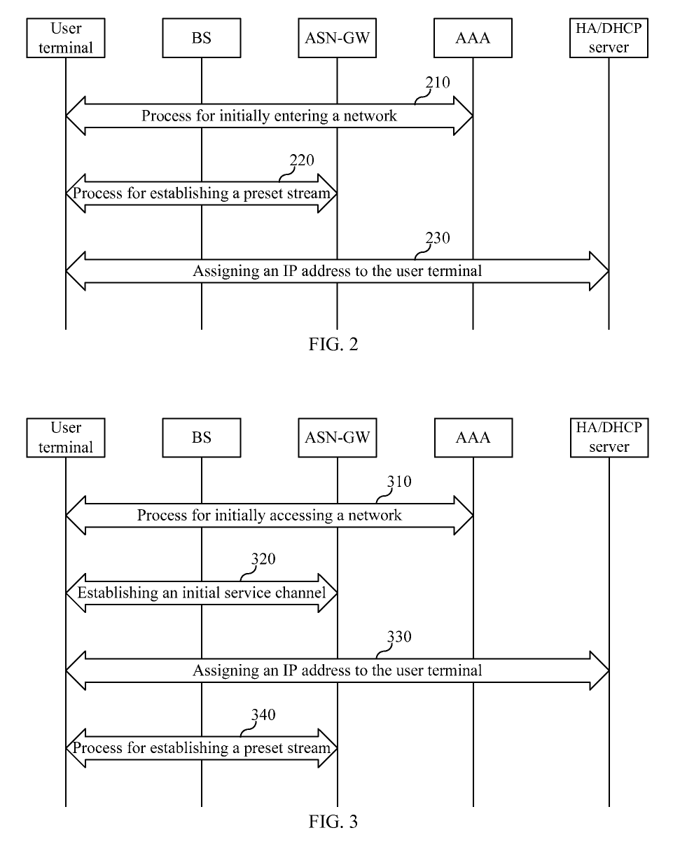

### DETAILED DESCRIPTION

The embodiments of the present invention will be described in further detail with reference to the accompanying drawings below.

According to an embodiment of the present invention, after the user terminal succeeds in accessing a network, an initial service flow for carrying Layer 3 signals is established between a network side and a user terminal, and an IP address is assigned to the user terminal through an interaction of the Layer 3 signals carried on the initial service flow. After the IP address has been assigned successfully, a classifier of preset stream is established by the network side with the IP address, and the parameters of the classifier of preset stream are set up. Alternatively, after the user terminal succeeds in accessing the network, a classifier of preset stream is established and its parameters are set up first, and after an IP address has been assigned to the user terminal successfully, the user terminal IP address parameter in the established classifier of preset stream is updated according to the assigned IP address. In this way, the IP address can be assigned to the user terminal by carrying signals on the established preset stream.

A system for establishing a classifier of preset stream according to a first embodiment of the present invention is illustrated below.

The system for establishing a classifier of preset stream according to an embodiment of the present invention includes: a channel establishing device, an address assigning device, and a classifier establishing device (a first classifier establishing device) at the network side. The channel establishing device at the network side is adapted to establish an initial service flow for carrying Layer 3 signals between the network side and a user terminal after the user terminal succeeds in accessing a network. The address assigning device at the network side is adapted to assign an IP address to the user terminal through an interaction of the Layer 3 signals on the initial service flow established by the channel establishing device. The classifier establishing device at the network side is adapted to establish a classifier of preset stream with the IP address and set up parameters of the classifier of preset stream after the address assigning device succeeds in assigning the IP address to the user terminal. The classifier of preset stream established at the network side includes an uplink classifier of preset stream and/or a downlink classifier of preset stream. For example, when it is needed to transmit a bidirectional service, an uplink classifier of preset stream and a downlink classifier of preset stream can be established at the same time; and when it is needed to transmit a unidirectional service (e.g., an uplink service or a downlink service), only an uplink classifier of preset stream or a downlink classifier of preset stream is established. Those skilled in the art should appreciate that, establishing an uplink classifier of preset stream at the network side in this application refers to that the network side configures the parameters of the uplink classifier of preset stream and sends them down to the terminal to achieve the uplink classifier of preset stream at the terminal side. Establishing a downlink classifier of preset stream at the network side in this application refers to that the network side configures the parameters of the downlink classifier of preset stream to achieve the downlink classifier of preset stream at the network side.

The system can further include a user terminal adapted to set up (i.e., modify) the parameters of the classifier of preset stream at the user terminal side with the IP address after the address assigning device succeeds in assigning the IP address to the user terminal.

In practical application, the channel establishing device at the network side in the system may be an ASN-GW or a BS, the address assigning device may be one or more of an ASN-GW, a home agent (HA), a dynamic host control protocol (DHCP) server, and an AAA server, and the classifier establishing device may be an ASN-GW or a BS.

The system according to an embodiment of the present invention has been illustrated above, and a method for establishing a classifier of preset stream according to an embodiment of the present invention is introduced in detail below.

As shown in FIG. 3, in Step 310, the user terminal initiates a process for initially accessing a network. After the user terminal succeeds in accessing the network, the process proceeds to Step 320. The user terminal succeeding in accessing the network refers to succeeding in the registration request/registration response (REG-REQ/REG-RSP) and the capability negotiation between the user terminal and the network side in the process of initially accessing a network.

In Step 320, the ASN-GW establishes an initial service flow for carrying Layer 3 signals between the network side and the user terminal.

In the process of establishing the initial service flow, a user terminal identifier, a service flow identifier (SF ID), a data path identifier (DP ID), and the relationship thereof are recorded by the ASN-GW, the air interface connection identifier (CID) of the initial service flow, the SF ID, the DP ID, and the relationship thereof are recorded by the BS, and the CID of the initial service flow, the SF ID, and the related context information are recorded by the user terminal.

The process then proceeds to Step 330, in which on the established initial service flow, the IP address of the user terminal is assigned through an interaction of the Layer 3 signals. The IP address assigned to the user terminal can be a home address (HoA) or care-of address (CoA) of a mobile IP user terminal, or an IP address of a simple IP user terminal. The Layer 3 signals interacted on the initial service flow includes a protocol message of the Dynamic Host Configuration Protocol version 4 (DHCPv4), a protocol message of the Dynamic Host Configuration Protocol version 6 (DHCPv6), a protocol message of the Mobile Internet Protocol version 4 (MIPv4), a protocol message of the Mobile Internet Protocol version 6 (MIPv6), a neighborhood discovery protocol message, and the like.

After the IP address has been assigned to the user terminal successfully, the process proceeds to Step 340, in which the related functional entity in the ASN-GW initiates a process for establishing a preset stream service. In the process, the ASN-GW establishes a downlink classifier of preset stream at the network side and/or an uplink classifier of preset stream at the user terminal side according to the assigned IP address of the user terminal, and set up the parameters of the established classifier of preset stream. Since the uplink and downlink classifier of preset stream are both established after the IP address has been assigned to the user terminal successfully, it can be ensured that in the process of establishing the uplink and/or downlink classifier of preset stream, the IP address parameter of the classifier is set up correctly, so that the established classifier of preset stream can normally classify the preset stream services of the user terminal, thus avoiding the phenomenon that the established classifier of preset stream cannot work normally due to the lack of the IP address of the user terminal in the prior art.

A method for establishing a classifier of preset stream according to a second embodiment of the present invention is substantially the same as that of the first embodiment, except that in the first embodiment, after the IP address has been assigned to the user terminal successfully, the related functional entity in the ASN-GW initiates the process of establishing a preset stream service, in which the ASN-GW establishes the classifier of preset stream at the user terminal side and/or the network side according to the IP address assigned successfully, while in this embodiment, after the IP address has been assigned to the user terminal successfully, the ASN-GW initiates a process of establishing a preset stream service, in which the BS establishes the classifier of preset stream at the user terminal side and/or the network side according to the IP address assigned successfully. That is, in this embodiment, the downlink classifier of preset stream and/or the uplink classifier of preset stream are established by the BS.

A system for establishing a classifier of preset stream according to a third embodiment of the present invention is illustrated below.

The system for establishing a classifier of preset stream in this embodiment is substantially the same as that of the first embodiment, and includes an address assigning device and a classifier establishing device, except that in this embodiment, the classifier establishing device is further adapted to establish a classifier of preset stream directly after the user terminal succeeds in accessing a network, and set up (i.e., modify) the parameters of the established classifier of preset stream according to the assigned IP address after the address assigning device succeeds in assigning the IP address to the user terminal.

A system for establishing a classifier of preset stream according to a fourth embodiment of the present invention is substantially the same as that of the first embodiment, and includes an address assigning device, a classifier establishing device (a second classifier establishing device), and a preset stream parameter modifying device, expect that in this embodiment, the classifier establishing device is adapted to establish a classifier of preset stream directly after the user terminal succeeds in accessing the network, the address assigning device assigns an IP address to the user terminal through a signal interaction on the established preset stream, and after the address assigning device succeeds in assigning the IP address to the user terminal, the preset stream parameter modifying device sets up (i.e., modifies) the IP address parameter of the user terminal in the established classifier of preset stream according to the assigned IP address.

The systems according to the third and fourth embodiments can further include an user terminal adapted to set up (i.e., modify) the parameters of the classifier of preset stream at the user terminal side (i.e., the uplink classifier of preset stream) with the IP address after the address assigning device succeeds in assigning the IP address to the user terminal.

In practical application, the address assigning device at the network side in the system may be one or more of an ASN-GW, a HA, a DHCP server, and an AAA server, and the classifier establishing device may be an ASN-GW or a BS.

The system of this embodiment has been illustrated above, and a method for establishing a classifier of preset stream of this embodiment is introduced in detail below.

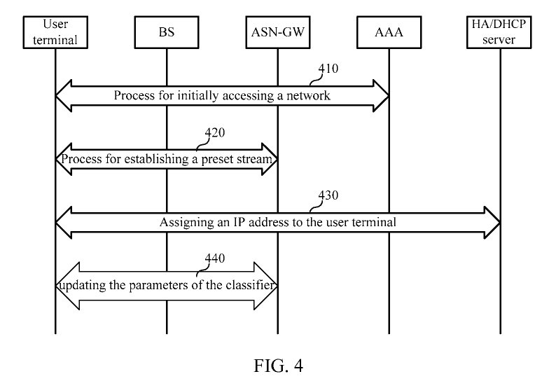

As shown in FIG. 4, in Step 410, the user terminal initiates a process for initially accessing a network, and after the user terminal succeeds in accessing the network, the process proceeds to Step 420.

In Step 420, the ASN-GW directly initiates a process for establishing a preset stream service, in which the BS establishes an uplink and/or downlink classifier of preset stream, and the IP address parameter of the established uplink and/or downlink classifier of preset stream is null.

The process then proceeds to Step 430, in which the HA or the DHCP server assigns an desired IP address to the user terminal by carrying Layer 3 signals on the established preset stream. After the IP address has been assigned successfully, the IP address assigned to the user terminal is recorded by the ASN-GW.

The process then proceeds to Step 440, in which the ASN-GW initiates a process for updating the preset stream according to the recorded IP address of the user terminal, and notifies the BS and/or the user terminal to update the IP address parameter for the established classifier of preset stream. After the user terminal and/or the BS receive the notification, the IP address parameter in the uplink classifier of preset stream and/or the downlink classifier of preset stream is updated according to the assigned IP address to ensure the correctness of the IP address parameters in the established uplink and downlink classifier of preset stream, so that the established classifier of preset stream can normally classify the preset stream services of the user terminal. Since this embodiment follows the flow of assigning the IP address after establishing the classifier of preset stream of the prior art, the embodiment of the present invention makes a minimum modification to the prior art, thus increasing the compatibility of the embodiment of the present invention with the prior art.

A method for establishing a classifier of preset stream according to a fifth embodiment of the present invention is substantially the same as that of the fourth embodiment, except that in the fourth embodiment, after the IP address has been assigned to the user terminal successfully, the ASN-GW initiates the process for updating the preset stream according to the IP address, and notifies the BS and/or the user terminal to update the IP address parameter in the established classifier of preset stream, while in this embodiment, after the IP address has been assigned to the user terminal successfully, the BS gets the assigned IP address by itself according to the downlink IP message, updates the IP address parameter of the downlink classifier of preset stream according to the IP address, and/or notifies the user terminal to update the IP address parameter of the classifier of uplink preset stream according to the IP address via an air interface message.

A method for establishing a classifier of preset stream according to a sixth embodiment of the present invention is substantially the same as that of the fourth embodiment, except that in the fourth embodiment, after the IP address has been assigned to the user terminal successfully, the ASN-GW initiates the process for updating the preset stream according to the IP address, and notifies the BS and/or the user terminal to update the IP address parameter in the established classifier of preset stream, while in this embodiment, after the IP address has been assigned to the user terminal successfully, the user terminal and/or the BS get the assigned IP address by themselves, and update the IP address parameters of the uplink and/or downlink classifier of preset stream according to the IP address actively.

A method for establishing a classifier of preset stream according to a seventh embodiment of the present invention is substantially the same as that of the fourth embodiment, except that in the fourth embodiment, in the process for establishing the preset stream service initiated by the ASN-GW, the uplink and/or downlink classifier of preset stream are established by the BS, while in this embodiment, in the process of establishing the preset stream service initiated by the ASN-GW, the uplink and/or downlink classifier of preset stream are established by the ASN-GW. After the IP address has been assigned successfully, the ASN-GW directly updates the IP address parameter of the downlink classifier of preset stream according to the IP address, and/or notifies the user terminal to update the IP address parameter of the uplink classifier of preset stream. Alternatively, after the IP address has been assigned successfully, the user terminal and/or the ASN-GW update the IP address parameters of the uplink and/or downlink classifier of preset stream through the internal primitive by themselves.

An eighth embodiment of the present invention is a user terminal, which at least includes a unit for establishing an initial service flow for carrying Layer 3 signals with the network side after the user terminal succeeds in accessing a network, a unit for getting an IP address assigned to the present user terminal by the network side through an interaction of the Layer 3 signals between the initial service flow and the network side, and a unit for setting up the parameters of the classifier of preset stream with the IP address after the IP address has been assigned successfully.

The user terminal of the embodiment of the present invention may ensure the correctness of the IP address of the user terminal in the established classifier of preset stream, so that the established classifier of preset stream can normally classify the preset stream services of the user terminal.

While the present invention has been shown and described with reference to some preferred embodiments thereof, those with ordinary skill in the art should appreciate that, various changes may be made in the form and details thereof without departing from the spirit and scope of the present invention.

What is claimed is:

1. A method for establishing a classifier of preset stream, comprising:
establishing an initial service flow between a network side and a user terminal for carrying signals after the user terminal succeeds in accessing a network;
assigning an IP address to the user terminal by the signals carried on the initial service flow; and
establishing a classifier of preset stream according to the IP address after the IP address has been assigned successfully.

2. The method for establishing a classifier of preset stream according to claim 1, wherein an access service network gateway or a base station at the network side establishes the classifier of preset stream and sets up the parameters thereof.

3. The method for establishing a classifier of preset stream according to claim 1, wherein the classifier of preset stream comprises an uplink classifier of preset stream or a downlink classifier of preset stream.

4. The method for establishing a classifier of preset stream according to claim 1, wherein the IP address assigned to the user terminal is a home address or care-of address of a mobile IP user terminal, or an IP address of a simple IP user terminal.

5. A method for establishing a classifier of preset stream, comprising:
establishing a classifier of preset stream after a user terminal succeeds in accessing a network, wherein the classifier of preset stream comprises an uplink classifier of preset stream or a downlink classifier of preset stream;
assigning an IP address to the user terminal by signals carried on the established preset stream; and
updating a user terminal IP address parameter in the established classifier of preset stream according to the assigned IP address after the IP address has been assigned successfully.

6. The method for establishing a classifier of preset stream according to claim 5, wherein an access service network gateway or a base station at the network side updates the user terminal IP address parameter in the established classifier of preset stream.

7. The method for establishing a classifier of preset stream according to claim 6, wherein the step of updating the user terminal IP address parameter in the established classifier of preset stream comprises:
notifying, by the access service network gateway at the network side, the base station of the recorded IP address assigned to the user terminal, and updating, by the base station, the user terminal IP address parameter in the established downlink classifier of preset stream according to the notification.

8. The method for establishing a classifier of preset stream according to claim 5, wherein an access service network gateway at the network side establishes the classifier of preset stream.

9. The method for establishing a classifier of preset stream according to claim 8, wherein the step of modifying the user terminal IP address parameter in the established classifier of preset stream comprises:
updating, by the access service network gateway, the user terminal IP address parameter in the established downlink classifier of preset stream according to the recorded IP address assigned to the user terminal.

10. A system for establishing a classifier of preset stream, comprising:
a channel establishing device adapted to establish an initial service flow between a network side and a user terminal for carrying signals after the user terminal succeeds in accessing a network;
an address assigning device adapted to assign an IP address to the user terminal through a signal interaction on the initial service flow established by the channel establishing device; and
a first classifier establishing device adapted to establish a classifier of preset stream with the IP address after the address assigning device succeeds in assigning the IP address to the user terminal.

11. The system for establishing a classifier of preset stream according to claim 10, wherein
the channel establishing device is an access service network gateway or a base station;
the address assigning device is one or any combination of:
an access service network gateway; a home agent; a dynamic host configuration protocol server; and an authentication, authorization and accounting server; and
the first classifier establishing device is an access service network gateway or a base station.

12. A system for establishing a classifier of preset stream, comprising:
a second classifier establishing device adapted to establish a classifier of preset stream after a user terminal succeeds in accessing a network;
an address assigning device adapted to assign an IP address to the user terminal by using signals on the established preset stream; and
a preset stream parameter modifying device adapted to modify a user terminal IP address parameter in the established classifier of preset stream according to the IP address assigned to the user terminal by the address assigning device.

13. The system for establishing a classifier of preset stream according to claim 12, wherein
the address assigning device is one or any combination of:
an access service network gateway; a home agent; a dynamic host configuration protocol server; and an authentication, authorization and accounting server; and
the second classifier establishing device is an access service network gateway or a base station.

14. The system for establishing a classifier of preset stream according to claim 12, wherein the classifier of preset stream comprises an uplink classifier of preset stream or a downlink classifier of preset stream, and the system further comprises:
a user terminal adapted to modify the user terminal IP address parameter in the established classifier of preset stream with the IP address after the address assigning device succeeds in assigning the IP address to the user terminal.

15. A user terminal, comprising:
a unit adapted to establish an initial service flow for carrying signals with a network side after the user terminal succeeds in accessing a network;
a unit adapted to acquire an IP address assigned to the user terminal by the network side through a signal interaction between the initial service flow and the network side; and
a unit adapted to set up the parameters of a classifier of preset stream with the IP address after the IP address has been assigned successfully.
